(19) United States
(12) Patent Application Publication
(10) Pub. No.: US 2015/0030532 A1
(43) Pub. Date: Jan. 29, 2015

(54) ANTIMICROBIAL MATERIAL COMPRISING A METAL ION CHARGED ON SYNTHESIZED ZEOLITE

(71) Applicant: YEDITEPE UNIVERSITESI, Istanbul (TR)

(72) Inventors: Fikrettin Sahin, Istanbul (TR); Nurcan Bac, Istanbul (TR); Selami Demirci, Istanbul (TR); Zeynep Ustaoglu, Istanbul (TR)

(21) Appl. No.: 14/368,691

(22) PCT Filed: Dec. 27, 2012
(86) PCT No.: PCT/IB2012/057753

§ 371 Date: Jun. 25, 2014

(30) Foreign Application Priority Data
Dec. 30, 2011 (TR) 2011/13331

(51) Int. Cl. A01N 59/20; C01B 39/22; C01B 39/14; C08K 3/28; C04B 22/12; C04B 22/08; C08K 3/30; C08K 3/16; A01N 59/16; C04B 22/14

(52) U.S. Cl. CPC A01N 59/20; A01N 59/16; C01B 39/22; C01B 39/14; C04B 22/142; C04B 22/12; C04B 22/085; C08K 3/30; C08K 3/16; C08K 3/28; C08K 2003/3045; C08K 2003/168
USPC 423/700

(57) ABSTRACT

The present invention relates to development of paint, plaster, cement and plastic construction materials containing silver, zinc and copper metal ion-charged zeolite ( 1/10 w/w). The new construction materials are antimicrobial and prevent microorganism growth and reproduction of fungi, yeasts and bacteria. The product, made from construction materials containing metallic ion-exchanged zeolite, provides hygiene by preventing microbial contamination in areas and surfaces for a long time. Furthermore, lifespan of the materials produced with this technology is longer since they will be protected from biological deterioration, corrosion and decays.

### FIELD OF THE INVENTION

The present invention relates to achieving construction materials such as plastic, cement, plaster and paint having antimicrobial feature.

### BACKGROUND OF THE INVENTION

Various factors such as changing living conditions, eating habits, increasing use of public transportation, proliferation of international travel means and the fact that individuals spend most of their time outside their homes cause people to interact with microorganisms more. Microorganisms such as fungi and bacteria can live almost anywhere in the world and some of them can lead to clinically significant illnesses among humans, animals and plants. Many studies have revealed the role of microorganisms in various natural phenomena as in nitrogen circle and their significance in terms of environmental and human health. Furthermore, microorganisms are increasingly used in scientific fields such as biotechnology, genetics and molecular biology thanks to genetic engineering methods. However, in addition to these useful microorganisms, there are primary and opportunistic pathogens leading to plant, animal and human deaths by influencing other organisms. Microorganisms in low concentrations observed outside health service areas such as surgery room can be accepted to be harmless. Nevertheless, when these harmless microorganisms reach large numbers, they increase the disease risk as well.

Antimicrobial agents such as antibiotics, antiseptics, disinfectants and synthetic drugs are used to reduce or eliminate the negative effects of the microorganisms. These agents allow in vivo and in vitro control of pathogenic microbial flora. Microorganisms cannot be controlled during surface applications performed with these agents when surfaces are not antimicrobial. Surface contamination due to microorganisms and prolonged stay of microorganisms on such surfaces increase infection risk. This situation can be more dangerous especially when public areas and hospital-related infection risks are considered. Therefore, antimicrobial surfaces and materials have been developed to control pathogens and minimize environmental and hospital-acquired infection risks. Even when they are cleaned frequently, common living areas, toilets and bathrooms or places requiring hygiene are the ideal places for microorganism reproduction due to humidity.

Antimicrobial surface production researches that are technically known attract considerable attention especially recently. Various antibacterial materials have been obtained as a result. But these products can ensure control of only bacteria responsible for the small part of infections in the world, not fungi or ferments.

Physical and chemical features of materials are the primary reason influencing microorganism colonization on material surfaces. Other than nutrients acquired from materials, humidity rate and penetration inside a material are among the main reasons triggering microbial growth. Therefore, growth of the microorganisms clinging to surfaces depends on a material's humidity absorption and humidity access capacity. Excessive amount of organic and inorganic nutrients taken from materials and moisture retention capacity in pores (when a material has a porous structure such as plaster) are among the reasons influencing microorganism growth and retention on a surface for a long time. Even when microorganisms growing on these surfaces are not pathogens, they pose great threat to the immunity systems of ill people, children and the old when they are in high concentrations. Microorganisms, especially when concentrated on surfaces in toilets, bathrooms and kitchens and public areas, may cause diseases, epidemics, acute and chronic allergic reactions depending on environmental and personal characteristics. Since the immune system of patients undergoing operation or chemotherapy is very weak, opportunistic pathogens which are not above normal level cause hospital-acquired epidemics and diseases. And people face high costs because this kind of hospital-acquired diseases prolong treatment and hospitalization time.

A research conducted in a 250-bed hospital revealed that annual costs incurred due to prolonged hospitalization periods and deaths caused by hospital-acquired diseases amount to approximately $200.000 [1]. Various protection programs are implemented to eliminate such high costs. However, precautions taken for controlling microorganisms passing due to contact with material surfaces (touching, inhalation and nutrition) are insufficient and ineffective.

Microorganisms settling on material surfaces cause materials to wear out and deteriorate as in the above-mentioned hygiene and health issues. Microorganisms reproduce by using organic and inorganic components on materials in addition to humidity in the air. During reproduction, they damage the structure of materials in different ways and make them dysfunctional. Microorganisms localized on metals cause metal corrosion and resistance loss during respiration. These surfaces deteriorate and lose their characteristics because microorganisms decompose nutrients in such products creating end products which also have decomposing features. Disinfectants and cleaners used for cleaning surface are not sufficient for microbial reproduction control and surface protection while they also cause significant financial losses. As a result of the studies, thousands of health-threatening microorganisms varying according to temperature and humidity rate have been isolated from houses, surfaces and objects [2]. These microorganisms also cause physical and chemical features of construction materials to change in closed areas. According to a research, mold damage in the buildings is estimated to be over [symbol] 200 million only in Germany [3]. Microorganisms which can grow on surfaces should be controlled to avoid such financial losses.

Concrete is one of the most important materials to be made antimicrobial. It is a widely used construction material. Durability, fire-resistance, water-tightness and sound insulation are among the most important reasons for using concrete as construction material. Millions of pores and microscopic capillary channels running throughout the concrete occur together with its formation. Humidity and gases can easily penetrate through these open channels. Therefore, different types of bacteria, yeasts and fungi moving inside the concrete through the same route can easily settle in these areas and form colonies by reproduction. Microorganisms settling in these parts pose infection risks for people contacting these surfaces while also causing concrete to wear off and lose resistance. Disinfectants are used for cleaning germs on concrete surfaces but it is not an efficient protection method as they cannot penetrate through pores where microorganisms come together. Also, this process needs to be repeated every day. Therefore concrete needs to have an antimicrobial characteristic to prevent wearing off and reduce environmental microbial infection risk.

Plaster, like concrete, is a construction material with a porous structure suitable for microorganism growth. Due to its humidity absorbing structure, it triggers growth of microorganisms, especially of molds. Microorganism growth on plaster is faster and easier compared to the concrete. Plaster allows spores and microorganisms in its pores to disperse into the air even during a small amount of airflow and increases people's infection risk through inhalation, especially for those living in such houses. Furthermore, humidity retention capacity is higher on plasters since they allow for fungal reproduction. When plaster is treated with water, it swells and its structure deteriorates.

Apart from plaster and cement, paints are other materials which is negatively influence by microorganisms. Paints are used for both visual purposes and protecting materials from physical damage. Paints are generally liquid and are applied on wood, metal, glass, ceramic, fiberglass, cardboard, paper, textile products, plastic, sponge or various polymers. For years, the paint industry have tried to develop a type of paint which can prevent microbial mold, yeast and bacteria growth on walls or other painted surfaces. Reducing disease and allergy risk by preventing microbial growth on painted surfaces poses a significant problem. And so does material abrasion caused by microorganisms reproducing with organic/inorganic paint components and humid air. Medical supply, kitchen and bathroom material surfaces, indoor areas and other object surfaces should be rendered antimicrobial to control pathogenic microorganism growth.

Known for a long time, antibacterial characteristics of metal ions have been the subject of many studies [4]. In these studies, antimicrobial properties of metal ions have been examined through ion-exchange over zeolite. The main structure of zeolite consists of SiO₄ and AlO₄ [5]. The most important aspect of this structure is that it involves considerable space and channels where water is released at high temperatures without causing deterioration while the structure also contains loosely bonded and changeable cations. Thus, zeolites are used successfully in adsorption, ion-exchange and dehydration practices. Cations present in the zeolite's skeletal structure can be exchanged with another ion when desired.

Ion-exchange capacities of zeolites depend on the silica/aluminum ratio in their formulation. Zeolite types with low silica/aluminum ratios generally enjoy high ion-exchange capacities [6,7]. Silver is the most common ion type used in ion-exchange processes of zeolites. The most important reason for silver usage is its antimicrobial feature [8]. Zeolites can be synthesized as antimicrobial products due to their ion-exchange characteristics. Silver zeolite has been tried on periodontium pathogens (Porphyromonas gingivalis, Prevotellain termedia, Actinobacillus actinomycetemcomitans, Streptococcus mutans, Streptococcus sanguis and Actinomyces viscosus) and it has been observed to have a positive effect on them [9].

In another study, stainless steel coated with silver and zinc containing zeolite was observed to be effective during inactivation of Bacillus types (B. anthracis, B. cereus, and B. subtilis) but ineffective on spores [10].

Yet another researcher reported that stainless steel coated with silver powder zeolite is effective on Escherichia coli 25922, Staphylococcus aureus 25923, Pseudomonas aeruginosa 27853, and Listeria monocytogenes 7644 [11].

Ion-exchange procedure can be not only applied on zeolites but also other minerals. Antibacterial characteristics of copper-loaded minerals have been searched in a study conducted on montmorillonite, a natural mineral [12]. Copper-loaded minerals (150 and 600 mg/L) were observed to be effective on Aeromonas hydrophile.

Malachová et al. identified antibacterial and antifungal effects of these compositions by charging montmorillonite with not only copper but also silver and zinc ions [13]. As a result of the studies conducted on E. Coli, silver-loaded montmorillonites and zinc-loaded minerals were observed to be the most and least effective mechanisms, respectively. Antifungal effects of metal-loaded montmorillonites were examined on Pycnoporus cinnabarinus and Pleurotus ostreatus. In comparison with other metals, zinc-loaded minerals were determined to have more antifungal effect on many tested microorganisms. Antibacterial effect of Na-clinoptilolite, a natural zeolite type, was evaluated through silver ion-exchange [14]. Silver-zeolites were tested on Pseudomonasa eruginosa and Escherichia coli and these materials were shown to have antibacterial characteristics.

Microbial growth on surfaces which are not antimicrobial may cause disease, acute and chronic allergies via contact, respiration or nutrition. Hospital-acquired infections are the most dangerous among these environmental diseases. Scientists have discovered that decreasing environmental pathogenic load is an important step in hospital-acquired disease reduction [15]. Hospital-acquired infections pass through contaminated surfaces or instruments in hospitals. Pathogenic microorganisms can survive on almost any surface causing infections and acting as the main driver behind acute and chronic allergy.

Yamaguchie et al. showed that vancomicyn-resistant Enterococci spp. is isolated from various surfaces such as wall, door knob, sheet, bed safety rail [16]. Surfaces in hospitals can be contaminated during usual clinic processes. In another study, it was reported that, seven days after a patient infected with varicella virus was hospitalized, the virus could be isolated from almost all surfaces in the room such as chair back, bed headboard, air conditioner [17].

Because of the above reasons, scientists exert great effort to render materials and surfaces antimicrobial in areas where especially people with weak defense mechanisms live. Various microbial growth-resistant products are intended to be developed with different methods. Products that should be sterile is given a priority during formation of such materials. Catheters used in surgeries account for 40% of hospital-acquired infections. This material has been made antibacterial thanks to silver ion coating [18].

Silver nano-particles were observed to be effective after being placed inside the silicone discs and applied on Staphylococcus epidermidis, which has a high surface adsorption and bio-film forming capacity [19].

Tesfaalem et al. showed that concrete coated with metal-charged zeolites is resistant to the bacterial abrasion [20]. The study revealed that zeolite-coated concrete has antibacterial effect against Acidothiobacillus thiooxidans.

Bright et al. showed with their experiment that zeolite-coated stainless steel charged with silver/zinc alloy ion has antibacterial effect [21]. Stainless steel containing 2.5% silver-zeolite and 14% zinc-zeolite was observed to have antibacterial effect on Staphylococcus aureus.

Silver and zinc ions were used together in another study to examine antibacterial characteristics of the surface after the nano-silica surface was charged with ions.

As a result of the study, the ion-loaded surface was determined to have an effect against E. coli ATCC 8739 and S. faecalis ATCC 10741 bacteria [22].

Metal ions such as silver, zinc and copper were used to create antibacterial surfaces and materials in various areas as part of other studies. They include water filter [23], paints [24], disinfectant [25], food coating material [26], gels [27] dental materials [28], ceramic [29] and paper.

The Korean Patent document no KR20020080632 discloses an antimicrobial paint type and coatings made from epoxy paint. However, the detailed description of the application reveals that the product is only antibacterial, its effect mechanism acting only against bacteria. Although the word “antimicrobial” is pronounced in the document it is observed to be effective only against bacteria.

Zeolites charged with metallic ion have been used only for antibacterial material production in the studies conducted until recently. In other words, these products have been effective against only bacteria, not yeast and fungi. Still, most of the infections in the world result from fungi and ferments. For this reason, materials used today as construction materials (such as paint, plastic, plaster and cement) are not antimicrobial and they cause various infections by carrying microbial loads.

### SUMMARY OF THE INVENTION

The objective of the present invention is to provide zeolite containing antifungal, anticandidal and antibacterial construction materials loaded with silver, copper and zinc metallic ions separately.

Another objective of the present invention is to provide hygiene for technological equipment, products or surfaces manufactured with such antimicrobial construction materials.

A further objective of the present invention is to provide protection against microbial deterioration, corrosion and decay on products and surfaces where these antimicrobial construction materials are used.

### DETAILED DESCRIPTION OF THE INVENTION

The antimicrobial materials developed to fulfill the objectives of the present inventions are shown in the accompanying figures wherein

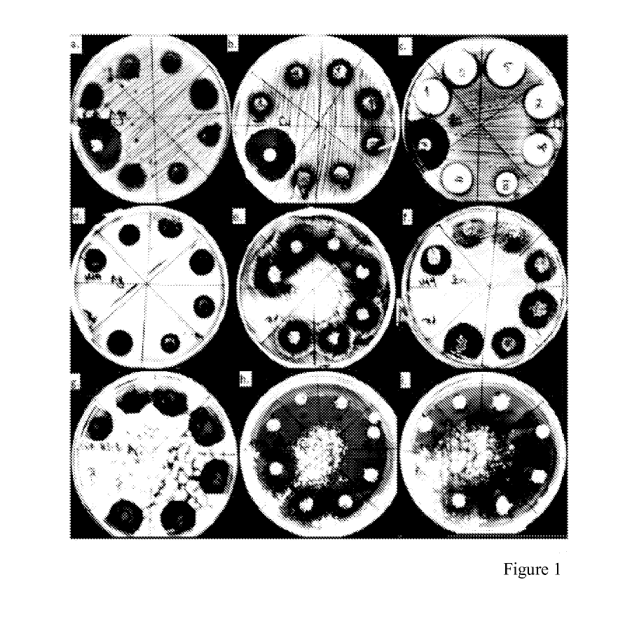

FIG. 1 is the antimicrobial effects of silver, copper and zinc ion exchanged zeolites against three different kinds of microorganisms (Staphylococcus aureus, Candida albicans, Penicillium charlesii).

FIG. 1-a: antibacterial effect of silver ion exchanged zeolite against Staphylococcus aureus

FIG. 1-b: antibacterial effect of copper ion exchanged zeolite against Staphylococcus aureus

FIG. 1-c: antibacterial effect of zinc ion exchanged zeolite against Staphylococcus aureus

FIG. 1-d: anticandidal effect of silver ion exchanged zeolite against Candida albicans

FIG. 1-e: anticandidal effect of copper ion exchanged zeolite against Candida albicans

FIG. 1-f: anticandidal effect of zinc ion exchanged zeolite against Candida albicans

FIG. 1-g: antifungal effect of silver ion exchanged zeolite against Penicillium charlesii

FIG. 1-h: antifungal effect of copper ion exchanged zeolite against Penicillium charlesii

FIG. 1-i: antifungal effect of zinc ion exchanged zeolite against Penicillium charlesii

FIG. 2: Antibacterial effect of metal ion exchanged zeolite blended metal paint against Pseudomonas aeruginosa

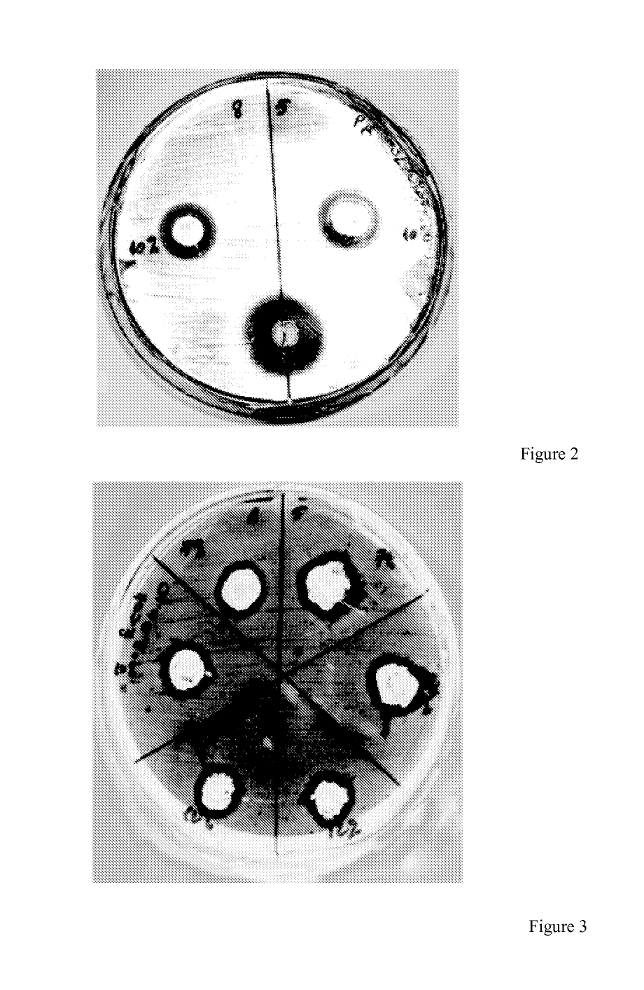

FIG. 3: Antibacterial effect of metal ion exchanged zeolite blended powder paint against Escherichia coli

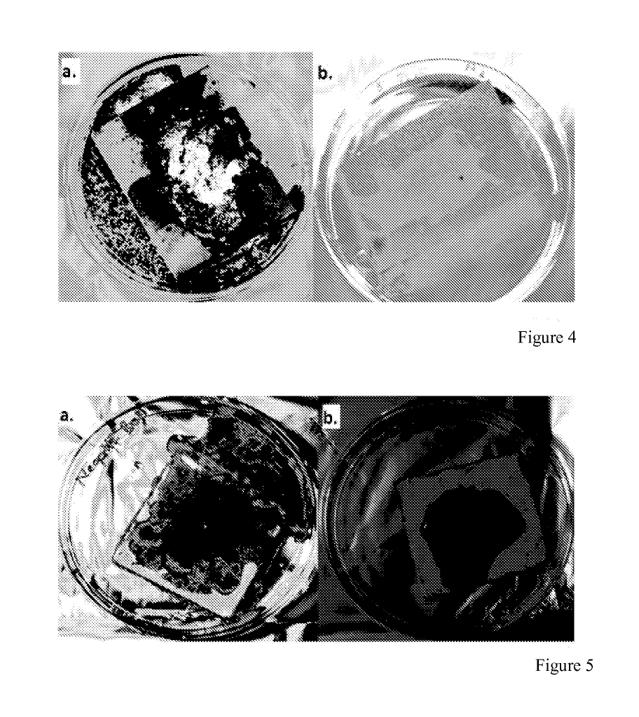

FIG. 4 is the view of effect of metal ion exchanged zeolite blended and not blended plastic paint on Aspergillus niger

FIG. 4a is the growth of Aspergillus niger on the plastic paint not blended with metal ion exchanged zeolite (standard).

FIG. 4-b: the antifungal effect of plastic paint blended with metal ion exchanged zeolite on Aspergillus niger

FIG. 5 is the view of effect of powder metal paint blended and not blended with metal ion exchanged zeolite on Botrytis cinerea

FIG. 5-a is the view of growth of Botrytis cinerea on the powder metal paint not blended with metal ion exchanged zeolite (standard).

FIG. 5-b the antifungal effect of powder metal paint blended with metal ion exchanged zeolite on Botrytis cinerea

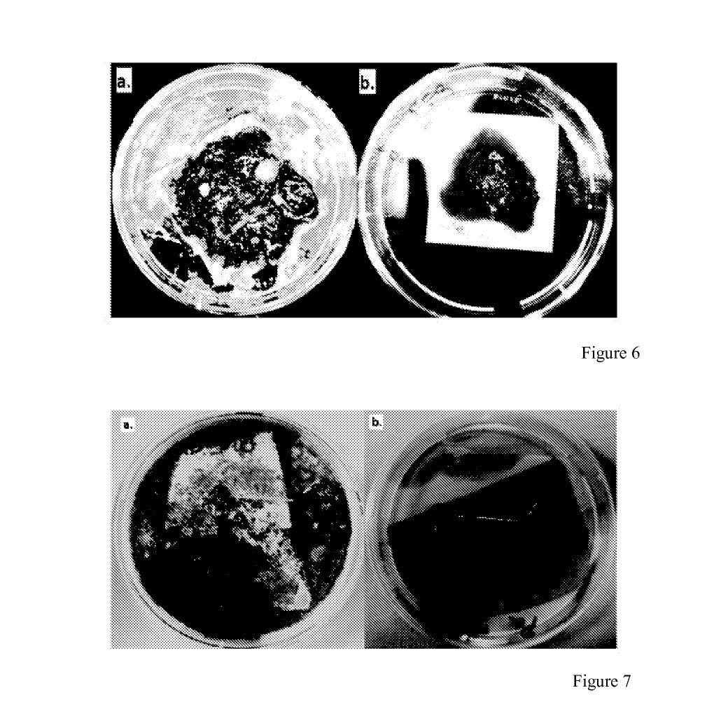

FIG. 6 is the view of effect of liquid metal paint blended and not blended with metal ion exchanged zeolite on Penicillium expansum

FIG. 6-a is the view of growth of Penicillium expansum on the liquid metal paint not blended with metal ion exchanged zeolite (standard).

FIG. 6-b the antifungal effect of liquid metal paint blended with metal ion exchanged zeolite against Penicillium expansum

FIG. 7 is the view of effect of plastic surface blended and not blended with metal ion exchanged zeolite on Fusarium oxysporium

FIG. 7-a is the growth of Fusarium oxysporiumon the plastic surface not blended with metal ion exchanged zeolite (standard).

FIG. 7-b: the antifungal effect of plastic surface blended with metal ion exchanged zeolite on Fusarium oxysporium

FIG. 8 is the effects of plaster moulds blended and not blended with metal ion exchanged zeolite against different kinds of fungi (Aspergillus niger, Fusarium oxysporium, Alternaria alternata, Sclerotinia sclerotiorum, Botrytris cinerea, Peniciullium expansum)

FIG. 8-a is the growth of different kinds of fungi (Aspergillus niger, Fusarium oxysporium, Alternaria alternata, Sclerotinia sclerotiorum, Botrytris cinerea, Peniciullium expansum) on plaster moulds not blended with metal ion exchanged zeolite (standard).

FIG. 8-b is the effects of plaster moulds blended with metal ion exchanged zeolite against different kinds of fungi (Aspergillus niger, Fusarium oxysporium, Alternaria alternata, Sclerotinia sclerotiorum, Botrytris cinerea, Peniciullium expansum)

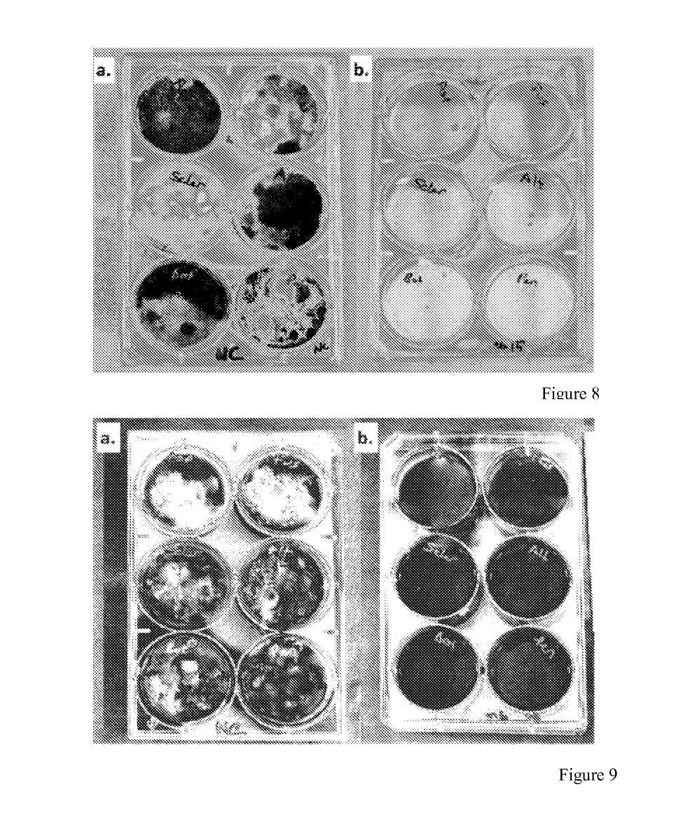

FIG. 9 is the effects of cement moulds blended and not blended with metal ion exchanged zeolite against different kinds of fungi (Aspergillus niger, Fusarium oxysporium, Alternaria alternata, Sclerotinia sclerotiorum, Botrytris cinerea, Peniciullium expansum)

FIG. 9-a is the growth of different kinds of fungi (Aspergillus niger, Fusarium oxysporium, Alternaria alternata, Sclerotinia sclerotiorum, Botrytris cinerea, Peniciullium expansum) on cement moulds not blended with metal ion exchanged zeolite (standard).

FIG. 9-b is the effects of cement moulds blended with metal ion exchanged zeolite against different kinds of fungi (Aspergillus niger, Fusarium oxysporium, Alternaria alternata, Sclerotinia sclerotiorum, Botrytris cinerea, Peniciullium expansum)

Construction materials not containing metal ion-exchanged zeolite (standard) were shown as negative control groups in all the tests.

### Experimental Studies

In synthesis of the inventive antimicrobial materials, first zeolite synthesis is performed.

### Zeolite Synthesis

Sodium metasilicate (Na₂O:SiO₂:5H₂O), sodium aluminate (Al₂O₃:1,4Na₂O), sodium hydroxide (NaOH:0.07H₂O) and water (H₂O) amounts required for zeolite types (Zeolite X and Zeolite A) with various silica alumina ratios were calculated as 8.71, 0.04, 2.57 and 88.68 grams, respectively. Water was divided into two parts and put into high density polyurethane containers. Only sodium metasilicate was added to one of these containers and dissolved. Sodium aluminate and sodium hydroxide were added to the other container to be completely dissolved. The mixtures in two containers were then mixed together and stirred until they formed a homogenous mixture. The new mixture was kept at 90° C. for 3 days for zeolite synthesis. The synthesized zeolite was filtered with vacuum filtration at the end of 3 days. It was dried at 90° C. for 24 hours. The acquired zeolite was converted into powder through blender or hand-pestle grinding. Silver, zinc and copper ion-exchange was performed to make the pulverized zeolites antimicrobial.

Charging Zeolite with Ion

For silver ion-exchange, a solution was prepared from 0.6-1 M 1 liter silver nitrate or other silver compounds capable of silver ion-exchange. 80 g of zeolite was added to the solution and it was stirred in dark for 3 days at RT, at 200-250 rpm.

For zinc ion-exchange, a 2M 1 liter zinc chloride solution was prepared. 80 g of zeolite was added to the solution and it was stirred in dark for 3 days at RT, at 200-250 rpm.

For copper ion-exchange, a 1M 1 liter copper sulfate solution was prepared. 80 g zeolite was added to the solution and it was stirred in dark for 3 days at RT, at 200-250 rpm.

The zinc, copper and silver ion-exchanged zeolites were filtered at the end of 3 days and dried at 90° C. for 24 hours. The acquired zeolite was converted into powder through blender or hand-pestle grinding.

### Antimicrobial Tests

### Modified Disc Diffusion Method

Standard NCCLS disc diffusion method [30] was used after modification to test the antimicrobial activity of products on each microorganism. Antimicrobial features of zeolite formulations charged with appropriate concentrations of silver, zinc and copper were examined through the application of modified disc diffusion method. The 100 μl solution including 10⁸ cfu/ml bacteria, 10⁶ cfu/ml yeast and 10⁴ spor/ml fungus was prepared with new cultures and was inoculated with diffusion method on nutrient agar (NA), Sabouraud Dextrose Agar (SDA) and Potato Dextrose Agar (PDA), respectively. 20 μl of sterile water was dropped on the empty discs and it was immersed into the pulverized metal-ion charged zeolite mixture. Empty discs coded with the metal charged zeolite were placed in inoculated petri dishes. Empty discs with 20 μl drop of sterile water were used as negative control. Ofloxacin (10 μg/disc) and nystatin (30 μg/disc) were used as positive control groups for bacteria and fungi, respectively. The petri dishes, on which inoculated and modified disc diffusion method were applied, was kept at 36±1° C. for bacteria for 24 hours and for yeasts 48 hours and at 25±1° C. for fungi for 72 hours. Antimicrobial activity inhibition area was measured and assessed for microorganisms tested with modified disc diffusion method. All tests were repeated at least twice.

### Preparing Antimicrobial Surface

Zeolites were first adhered to the empty discs after being wetted with distilled water (20 μl) prior to testing their antimicrobial features. After the microorganisms to be tested were inoculated to the appropriate nutrient media (PDA, SDA, and TSA), discs coded with ion-exchanged zeolite were placed on them and these microorganisms were incubated 1-7 days Inhibition area formation (the part where microorganisms do not grow) following the incubation around the discs in each medium was identified as antimicrobial effect against tested microorganisms.

Antimicrobial effects of the antimicrobial product was examined on microorganisms after silver-zeolite (0.3-1 M silver nitrate), zinc-zeolite (0.5-2 M zinc chloride) and copper-zeolite (0.3-1 M copper sulfate) solutions were added into liquid paints on the market and powder paints used in the white goods industry. Antimicrobial activities of the paints were determined according to the above-mentioned modified disc diffusion method. Metal-charged zeolites were mixed with commercial liquid paint with a 1/10 (w/w) ratio. According to this, 1 gr zeolite was mixed with 9 g of paint. Metal plates (˜16 cm²) were painted with this paint preparation. Some metal plates were painted with raw paint not containing zeolite to be used as a negative control group. The painted plates were dried at room temperature and put into the empty petri dishes to reduce contamination risk. Fungus inoculation was conducted with sterile cotton swaps after 1 ml of Sabouraud Dextrose Broth was put on the plates. The metal plates were incubated at room temperature and 1 ml of Sabouraud Dextrose Broth was added on them every day for fungus, yeast and bacteria growth examination.

The antimicrobial product was mixed inside the commercially available cement and plaster with a 1/10 (w/w) ratio after its silver-zeolite and zinc-zeolite concentration was determined as 2M and 0.6-1 M, respectively. Only zinc-zeolite was added to the plaster while zinc- or silver-zeolite was added to cement. 10 ml of solution from the prepared products was put into 6-well cell culture plates and dried at room temperature for 2 days. 1 ml of Sabouraud Dextrose Broth (SDB) was added to the prepared surfaces and contamination was applied on fungi, bacteria and yeast cultures to be tested. The fungal growth was observed every day after the addition of 1 ml of Sabouraud Dextrose Broth to the cement and plaster surfaces.

Experimental studies were carried out with certain fungus, yeast and bacteria types. The bacteria whose effect mechanisms were observed in these experimental studies are Escherichia coli, Staphylococcus aureus, Pseudomonas aeruginosa, Bacillus megaterium, Bacillus subtilis, Enterococcus faecium, Pseudoxanthomonas spp., Nocardia brasiliensis, Nocardia globerula, Pseudomonas maculicola, Bacillus coagulans, Acinetobacter baumannii, Stenotrophomonas maltophlia, Pantoea stewartii ss stewartii, Pseudomanas chlororaphis, Chryseobacterium balustinus, Duganella zoogloeoides, Chryseobacterium meningosepticum, Staphylococcus hominis, Nocardia transvalensis, Burkolderia glumea, Pediococcus acidilactici/parvulus, Sphingomonas terse, Corynebacterium spp., Gordonia rubripertincta, Rhodococcus rhodnii, Brevundimonas vesicularis, Acinetobacter calcoaceticus, Providencian heimbachae, Gordonia sputi, Pseudomonas putida, Cellulosimicrobium cellulans, Sphingomonas sanguinis, Hydrogenophaga pseudoflava, Actinomadura cremea, Pseudomonas flourescens, Xanthomonas spp.

The yeasts whose effect mechanisms were observed in the experimental studies are Candida albicans, Candida parapsilosis, Candida tropicalis, Candida glabrata, Kluyveromyces marxianus, Hyphopichia burtanii ve kullanilan kiifler; Fusarium oxysporum, Botrytis cinerea, Aspergillus niger, Alternaria alternate, Penicillium vinaceum, Penicillium expansum, Sclerotinia sclerotiorum, Paecilomyces lilacinus, Penicillium charlesii, Penicillium expansum.

### Time-Dependent Antimicrobial Life Test

In this study, suitable nutient medium (1 ml) was dropped on the surfaces prepared from construction materials such as paint, plaster, cement, plastic which are containing/not containing silver and zinc-zeolite; and these surfaces were contaminated with different microorganisms such as bacteria, yeast, fungus. Accelerated life tests were conducted to understand whether they preserve their antimicrobial features depending on time. Accordingly, microbially-contaminated surfaces made from construction materials containing/not containing silver and zinc zeolite were maintained for a year in special incubators (36±1° C. for bacteria and ferments, 25±1° C. for fungi). In the meantime, nutrient medium was consolidated constantly to encourage microbial growth and development on microbially-contaminated surfaces. Whether microbial growth on these surfaces occurred was determined by performing monthly retroactive isolation process on the tested construction materials. The test results at the end of one-year incubation duration are summarized on Table 1 and Table 2.

### Experiment Results

The results of the modified disc diffusion test conducted on petri in vitro show the antibacterial effect of discs coded with silver, copper and zinc ion-exchanged zeolites against Staphylococcus aureus (FIGS. 1a, b, c). Bacteria growth was observed in all parts of the petri whereas no bacterial growth was observed around the discs coded with the metal ion-exchanged zeolite. Similarly, anticandidal and antifungal effects of the discs coded with silver, copper and zinc ion-exchanged zeolite were observed against Candida albicans FIG. 1d, e, J), and Penicillium charlesii (FIG. 1g, h, i), respectively Inhibition area was observed only around metal ion-exchanged zeolite discs in yeast (Candida albicans) and fungus (Penicillium charlesii) inoculated media (FIG. 1).

Another experimental study shows antibacterial effects of the metal paint containing metal (zinc, silver) ion-exchanged zeolite ( 1/10 w/w) against Pseudomonas aeruginosa, inoculated in vitro. While growth is observed all parts of the inoculated petri, inhibition area is observed around the metal ion-exchanged zeolite discs (FIG. 2).

Antibacterial effects of the metal (silver, zinc) ion-exchanged zeolite-containing powder paint ( 1/10 w/w) are observed against Escherichia coli, inoculated in vitro Inhibition area is observed around the discs with powder paint (containing metal ion-exchanged zeolite) used in the white goods industry (FIG. 3).

After nutrient medium is dropped on metal plates painted with plastic paint containing/not containing metal (silver) ion-exchanged zeolite, they were contaminated with Aspergillus niger fungus and micella growth and fungal sporification were examined. Fungal reproduction was not observed (FIG. 4b) for 12 months on the metal surface coated with paint containing silver ion-exchanged zeolite ( 1/10 w/w) whereas fungal growth and intense sporification were observed after 72 hours on surfaces coated with paints which do not contain zeolite (FIG. 4a).

Metal plates painted with powder paint containing/not containing metal (zinc) ion-exchanged zeolite ( 1/10 w/w) were contaminated with the Botrytis cinerea fungus after the liquid nutrient medium was dropped on them and micella growth and fungal sporification was examined. Fungal reproduction was not observed for 12 months on metal surface coated with powder paint containing zinc ion-exchanged zeolite (FIG. 5b) whereas fungal growth and intense sporification were observed after 72 hours on surfaces coated with paints not which do not contain zeolite (FIG. 5a).

Metal plates painted with liquid paint which are containing/not containing metal (silver) ion-exchanged zeolite were contaminated with the Penicillium expansum fungus after the liquid nutrient medium was dropped on them and micella growth and fungal sporification was examined. Fungal reproduction was not observed (FIG. 6b) for 12 months on metal surface coated with metal paint which is containing silver ion-exchanged zeolite ( 1/10 w/w) whereas fungal growth and intense sporification was observed 72 hours later on surfaces coated with paints which do not contain zeolite (FIG. 6a).

Plastic surface which is containing/not containing metal (silver) ion-exchanged zeolite was contaminated with the Fusarium oxysporium fungus after the liquid nutrient medium was dropped on it and micella growth and fungal sporification was examined. Fungal reproduction was not observed for 12 months (FIG. 7b) on plastic surface containing silver ion-exchanged zeolite ( 1/10 w/w) whereas fungal growth and intense sporification was observed 72 hours later on surfaces coated with paint which is not containing zeolite (FIG. 7a).

Plaster casts were prepared inside 6-well cell culture plates with the use of standard (commercial) plaster which is containing/not containing in vitro metal (zinc) ion-exchanged zeolite ( 1/10 w/w). Plaster casts in each well were examined in terms microbial development duration after addition of an appropriate liquid nutrient medium (1 ml) on them and subsequent to their contamination by certain fungus (Aspergillus niger, Fusarium oxysporium, Alternaria alternate, Sclerotinia sclerotiorum, Botrytris cinerea, Peniciullium expansum) cultures. According to the results obtained, microbial growth was not observed for 12 months (FIG. 8b) on plaster casts which are containing metal ion-exchanged zeolite whereas it was observed on pure standard plaster casts 72 later (FIG. 8a).

Cement moulds were prepared inside 6-well cell culture plates with the use of standard (commercial) cement which is containing/not containing in vitro metal (silver) ion-exchanged zeolite ( 1/10 w/w). Cement casts in each well were examined in terms microbial development duration after the addition of an appropriate liquid nutrient medium (1 ml) on them and subsequent to their contamination by certain fungus (Aspergillus niger, Fusarium oxysporium, Alternaria alternate, Sclerotinia sclerotiorum, Botrytris cinerea, Peniciullium expansum) cultures. According to the results obtained, microbial growth was not observed for 12 months (FIG. 9b) on cement moulds which are containing metal ion-exchanged zeolite whereas it was observed on pure standard cement casts 10 days later (FIG. 9a).

The surfaces which is containing/not containing metal ion-exchanged zeolite were contaminated with all fungus, bacteria and yeast cultures to be tested and microbial growth was observed for 12 months. At the end of this period, monthly retroactive isolation tests showed that zeolite containing construction materials (paint, plastic, plaster and cement) preserved their antimicrobial characteristics not allowing any microbial development (bacteria, yeast and fungus) or growth. The growth of the bacteria and yeasts in the antimicrobial tests of the construction materials are not demonstrate in FIG. 4-9 since they cannot be illustrated as pictures. The bacteria and yeast growth on surfaces are summarized in Table 1 and Table 2.

The antimicrobial construction material reached through this invention has a wide area of use. Construction materials containing metal ion-charged zeolite can be used through different methods in metal paints, on all kinds of plastic household appliances, medical instruments necessary for hygiene in hospitals and clinics, all painted metal and plastic surfaces in public areas, interior/exterior wall paints and coatings, vehicle surfaces, metal and plastic components of air conditioners, surfaces of technological products such as television.

TABLE 1
Results of the 12-month time-dependent antimicrobial life test conducted on the surfaces made from construction
materials reinforced/pure with Zinc-Zeolite (1/10 w/w^{a})

| | PAINT | | | | | | | | | | | | | |
|---|---|---|---|---|---|---|---|---|---|---|---|---|---|---|
| | POWDER PAINT | | PLASTIC PAINT | | SATIN PAINT | | METAL PAINT | | PLASTER | | CEMENT | | PLASTIC | |
| | | Non | | Non | | Non | | Non | | Non | | Non | | Non |
| | Contain- | contain- | Rein- | contain- | Rein- | contain- | Contain- | contain- | Contain- | contain- | Contain- | contain- | contain- | contain- |
| | ing | ing | forced | ing | forced | ing | ing | ing | ing | ing | ing | ing | ing | ing |
| BACTERIA | | | | | | | | | | | | | | |
| Escherichia coli | − ^{b} | +^{b} | − | + | − | + | − | + | − | + | − | + | − | + |
| Staphylococcus | − | + | − | + | − | + | − | + | − | + | − | + | − | + |
| aureus | | | | | | | | | | | | | | |
| Pseudomonas | − | + | − | + | − | + | − | + | − | + | − | + | − | + |
| aeruginosa | | | | | | | | | | | | | | |
| Bacillus | − | + | − | + | − | + | − | + | − | + | − | + | − | + |
| megaterium | | | | | | | | | | | | | | |
| Bacillus subtilis | − | + | − | + | − | + | − | + | − | + | − | + | − | + |
| Enterococcus | − | + | − | + | − | + | − | + | − | + | − | + | − | + |
| faecium | | | | | | | | | | | | | | |
| Pseudoxantho- | − | + | − | + | − | + | − | + | − | + | − | + | − | + |
| monas spp. | | | | | | | | | | | | | | |
| Nocardia | − | + | − | + | − | + | − | + | − | + | − | + | − | + |
| brasiliensis | | | | | | | | | | | | | | |
| Nocardia | − | + | − | + | − | + | − | + | − | + | − | + | − | + |
| globerula | | | | | | | | | | | | | | |
| Pseudomonas | − | + | − | + | − | + | − | + | − | + | − | + | − | + |
| maculicola | | | | | | | | | | | | | | |
| Bacillus | − | + | − | + | − | + | − | + | − | + | − | + | − | + |
| coagulans | | | | | | | | | | | | | | |
| Acinetobacter | − | + | − | + | − | + | − | + | − | + | − | + | − | + |
| baumannii | | | | | | | | | | | | | | |
| Stenotrophomo- | − | + | − | + | − | + | − | + | − | + | − | + | − | + |
| nas maltophlia | | | | | | | | | | | | | | |
| Pantoea stewar- | − | + | − | + | − | + | − | + | − | + | − | + | − | + |
| tiiss stewartii | | | | | | | | | | | | | | |
| Pseudomanas | − | + | − | + | − | + | − | + | − | + | − | + | − | + |
| chlororaphis | | | | | | | | | | | | | | |
| Chryseobacter- | − | + | − | + | − | + | − | + | − | + | − | + | − | + |
| ium balustinus | | | | | | | | | | | | | | |
| Duganella | − | + | − | + | − | + | − | + | − | + | − | + | − | + |
| zoogloeoides | | | | | | | | | | | | | | |
| Chryseobacter- | − | + | − | + | − | + | − | + | − | + | − | + | − | + |
| ium menin- | | | | | | | | | | | | | | |
| gosepticum | | | | | | | | | | | | | | |
| Staphylococcus | − | + | − | + | − | + | − | + | − | + | − | + | − | + |
| hominis | | | | | | | | | | | | | | |
| Nocardia | − | + | − | + | − | + | − | + | − | + | − | + | − | + |
| transvalensis | | | | | | | | | | | | | | |
| Burkolderia | − | + | − | + | − | + | − | + | − | + | − | + | − | + |
| glumea | | | | | | | | | | | | | | |
| Pediococcus | − | + | − | + | − | + | − | + | − | + | − | + | − | + |
| acidilactici | | | | | | | | | | | | | | |
| Sphingomonas | − | + | − | + | − | + | − | + | − | + | − | + | − | + |
| terrae | | | | | | | | | | | | | | |
| Corynebacter- | − | + | − | + | − | + | − | + | − | + | − | + | − | + |
| ium spp. | | | | | | | | | | | | | | |
| Gordonia | − | + | − | + | − | + | − | + | − | + | − | + | − | + |
| rubripertincta | | | | | | | | | | | | | | |
| Rhodococcus | − | + | − | + | − | + | − | + | − | + | − | + | − | + |
| rhodnii | | | | | | | | | | | | | | |
| Brevundimonas | − | + | − | + | − | + | − | + | − | + | − | + | − | + |
| vesicularis | | | | | | | | | | | | | | |
| Acinetobacter | − | + | − | + | − | + | − | + | − | + | − | + | − | + |
| calcoaceticus | | | | | | | | | | | | | | |
| Providencian | − | + | − | + | − | + | − | + | − | + | − | + | − | + |
| heimbachae | | | | | | | | | | | | | | |
| Gordonia sputi | − | + | − | + | − | + | − | + | − | + | − | + | − | + |
| Pseudomonas | − | + | − | + | − | + | − | + | − | + | − | + | − | + |
| putida | | | | | | | | | | | | | | |
| Cellulosimicro- | − | + | − | + | − | + | − | + | − | + | − | + | − | + |
| bium cellulans | | | | | | | | | | | | | | |
| Acinetobacter | − | + | − | + | − | + | − | + | − | + | − | + | − | + |
| genomospecies | | | | | | | | | | | | | | |
| Sphingomonas | − | + | − | + | − | + | − | + | − | + | − | + | − | + |
| sanguinis | | | | | | | | | | | | | | |
| Hydrogenopha- | − | + | − | + | − | + | − | + | − | + | − | + | − | + |
| ga pseudoflava | | | | | | | | | | | | | | |
| Actinomadura | − | + | − | + | − | + | − | + | − | + | − | + | − | + |
| cremea | | | | | | | | | | | | | | |
| Pseudomonas | − | + | − | + | − | + | − | + | − | + | − | + | − | + |
| flourescens | | | | | | | | | | | | | | |
| Xanthomonas | − | + | − | + | − | + | − | + | − | + | − | + | − | + |
| spp. | | | | | | | | | | | | | | |
| YEASTS | | | | | | | | | | | | | | |
| Candida | − | + | − | + | − | + | − | + | − | + | − | + | − | + |
| albicans | | | | | | | | | | | | | | |
| Candida | − | + | − | + | − | + | − | + | − | + | − | + | − | + |
| parapsilosis | | | | | | | | | | | | | | |
| Candida | − | + | − | + | − | + | − | + | − | + | − | + | − | + |
| tropicalis | | | | | | | | | | | | | | |
| Candida | − | + | − | + | − | + | − | + | − | + | − | + | − | + |
| glabrata | | | | | | | | | | | | | | |
| Kluyveromyces | − | + | − | + | − | + | − | + | − | + | − | + | − | + |
| marxianus | | | | | | | | | | | | | | |
| Hyphopichia | − | + | − | + | − | + | − | + | − | + | − | + | − | + |
| burtanii | | | | | | | | | | | | | | |
| MOLDS | | | | | | | | | | | | | | |
| Aspergillus | − | + | − | + | − | + | − | + | − | + | − | + | − | + |
| niger | | | | | | | | | | | | | | |
| Fusarium | − | + | − | + | − | + | − | + | − | + | − | + | − | + |
| oxysporum | | | | | | | | | | | | | | |
| Botrytis | − | + | − | + | − | + | − | + | − | + | − | + | − | + |
| cinerea | | | | | | | | | | | | | | |
| Alternaria | − | + | − | + | − | + | − | + | − | + | − | + | − | + |
| alternata | | | | | | | | | | | | | | |
| Paecilomyces | − | + | − | + | − | + | − | + | − | + | − | + | − | + |
| lilacinus | | | | | | | | | | | | | | |
| Penicillium | − | + | − | + | − | + | − | + | − | + | − | + | − | + |
| expansum | | | | | | | | | | | | | | |

^{a} shows that the applied Zinc-Zeolit ratio is weight/weight.
^{b} + mark shows refers to microbial development and growth on the construction material surfaces.
− mark refers to the absence of microbial development and growth on the construction material surfaces.

TABLE 2
Results of the 12-month time-dependent antimicrobial life test conducted on the surfaces made from construction materials
reinforced/pure with Silver-Zeolite (1/10 w/w^{a})

| | PAINT | | | | | | | | | | | |
|---|---|---|---|---|---|---|---|---|---|---|---|---|
| | POWDER PAINT | | PLASTIC PAINT | | SATIN PAINT | | METAL PAINT | | CEMENT | | PLASTIC | |
| | | Non | | Non | | Non | | Non | | Non | | Non |
| | contain- | contain- | rein- | contain- | rein- | contain- | contain- | contain- | contain- | contain- | contain- | contain- |
| | ing | ing | forced | ing | forced | ing | ing | ing | ing | ing | ing | ing |
| BACTERIA | | | | | | | | | | | | |
| Escherichia coli | − ^{b} | +^{b} | − | + | − | + | − | + | − | + | − | + |
| Staphylococcus aureus | − | + | − | + | − | + | − | + | − | + | − | + |
| Pseudomonas aeruginosa | − | + | − | + | − | + | − | + | − | + | − | + |
| Bacillus megaterium | − | + | − | + | − | + | − | + | − | + | − | + |
| Bacillus subtilis | − | + | − | + | − | + | − | + | − | + | − | + |
| Enterococcus faecium | − | + | − | + | − | + | − | + | − | + | − | + |
| Pseudoxanthomonas spp. | − | + | − | + | − | + | − | + | − | + | − | + |
| Nocardia brasiliensis | − | + | − | + | − | + | − | + | − | + | − | + |
| Nocardia globerula | − | + | − | + | − | + | − | + | − | + | − | + |
| Pseudomonas maculicola | − | + | − | + | − | + | − | + | − | + | − | + |
| Bacillus coagulans | − | + | − | + | − | + | − | + | − | + | − | + |
| Acinetobacter baumannii | − | + | − | + | − | + | − | + | − | + | − | + |
| Stenotrophomonas maltophlia | − | + | − | + | − | + | − | + | − | + | − | + |
| Pantoea stewartii ss stewartii | − | + | − | + | − | + | − | + | − | + | − | + |
| Pseudomanas chlororaphis | − | + | − | + | − | + | − | + | − | + | − | + |
| Chryseobacterium balustinus | − | + | − | + | − | + | − | + | − | + | − | + |
| Duganella zoogloeoides | − | + | − | + | − | + | − | + | − | + | − | + |
| Chryseobacterium meningosepticum | − | + | − | + | − | + | − | + | − | + | − | + |
| Staphylococcus hominis | − | + | − | + | − | + | − | + | − | + | − | + |
| Nocardia transvalensis | − | + | − | + | − | + | − | + | − | + | − | + |
| Burkolderia glumea | − | + | − | + | − | + | − | + | − | + | − | + |
| Pediococcus acidilactici | − | + | − | + | − | + | − | + | − | + | − | + |
| Sphingomonas terrae | − | + | − | + | − | + | − | + | − | + | − | + |
| Corynebacterium spp. | − | + | − | + | − | + | − | + | − | + | − | + |
| Gordonia rubripertincta | − | + | − | + | − | + | − | + | − | + | − | + |
| Rhodococcus rhodnii | − | + | − | + | − | + | − | + | − | + | − | + |
| Brevundimonas vesicularis | − | + | − | + | − | + | − | + | − | + | − | + |
| Acinetobacter calcoaceticus | − | + | − | + | − | + | − | + | − | + | − | + |
| Providencian heimbachae | − | + | − | + | − | + | − | + | − | + | − | + |
| Gordonia sputi | − | + | − | + | − | + | − | + | − | + | − | + |
| Pseudomonas putida | − | + | − | + | − | + | − | + | − | + | − | + |
| Cellulosimicrobium cellulans | − | + | − | + | − | + | − | + | − | + | − | + |
| Acinetobacter genomospecies | − | + | − | + | − | + | − | + | − | + | − | + |
| Sphingomonas sanguinis | − | + | − | + | − | + | − | + | − | + | − | + |
| Hydrogenophaga pseudoflava | − | + | − | + | − | + | − | + | − | + | − | + |
| Actinomadura cremea | − | + | − | + | − | + | − | + | − | + | − | + |
| Pseudomonas flourescens | − | + | − | + | − | + | − | + | − | + | − | + |
| Xanthomonas spp. | − | + | − | + | − | + | − | + | − | + | − | + |
| FERMENTS | | | | | | | | | | | | |
| Candida albicans | − | + | − | + | − | + | − | + | − | + | − | + |
| Candida parapsilosis | − | + | − | + | − | + | − | + | − | + | − | + |
| Candida tropicalis | − | + | − | + | − | + | − | + | − | + | − | + |
| Candida glabrata | − | + | − | + | − | + | − | + | − | + | − | + |
| Kluyveromyces marxianus | − | + | − | + | − | + | − | + | − | + | − | + |
| Hyphopichia burtanii | − | + | − | + | − | + | − | + | − | + | − | + |
| MOLDS | | | | | | | | | | | | |
| Aspergillus niger | − | + | − | + | − | + | − | + | − | + | − | + |
| Fusarium oxysporum | − | + | − | + | − | + | − | + | − | + | − | + |
| Botrytis cinerea | − | + | − | + | − | + | − | + | − | + | − | + |
| Alternaria alternata | − | + | − | + | − | + | − | + | − | + | − | + |
| Paecilomyces lilacinus | − | + | − | + | − | + | − | + | − | + | − | + |
| Penicillium expansum | − | + | − | + | − | + | − | + | − | + | − | + |

^{a} shows that the applied Silver-Zeolit ratio is weight/weight.
^{b} + mark shows refers to microbial development and growth on the construction material surfaces.
− mark refers to the absence of microbial development and growth on the construction material surfaces.

TABLE 2
Results of the 12-month time-dependent antimicrobial life test conducted on the surfaces made from construction
materials reinforced/pure with Silver-Zeolite (1/10 w/w^{a})

| | PAINT | | | | | | | | | | | | | |
|---|---|---|---|---|---|---|---|---|---|---|---|---|---|---|
| | POWDER PAINT | | PLASTIC PAINT | | SATIN PAINT | | METAL PAINT | | PLASTER | | CEMENT | | PLASTIC | |
| | | Non | | Non | | Non | | Non | | Non | | Non | | Non |
| | Contain- | contain- | Rein- | contain- | Rein- | contain- | Contain- | contain- | Contain- | contain- | Contain- | contain- | contain- | contain- |
| | ing | ing | forced | ing | forced | ing | ing | ing | ing | ing | ing | ing | ing | ing |
| BACTERIA | | | | | | | | | | | | | | |
| Escherichia coli | −^{b} | +^{b} | − | + | − | + | − | + | − | + | − | + | − | + |
| Staphylococcus | − | + | − | + | − | + | − | + | − | + | − | + | − | + |
| aureus | | | | | | | | | | | | | | |
| Pseudomonas | − | + | − | + | − | + | − | + | − | + | − | + | − | + |
| aeruginosa | | | | | | | | | | | | | | |
| Bacillus | − | + | − | + | − | + | − | + | − | + | − | + | − | + |
| megaterium | | | | | | | | | | | | | | |
| Bacillus subtilis | − | + | − | + | − | + | − | + | − | + | − | + | − | + |
| Enterococcus | − | + | − | + | − | + | − | + | − | + | − | + | − | + |
| faecium | | | | | | | | | | | | | | |
| Pseudoxantho- | − | + | − | + | − | + | − | + | − | + | − | + | − | + |
| monas spp. | | | | | | | | | | | | | | |
| Nocardia | − | + | − | + | − | + | − | + | − | + | − | + | − | + |
| brasiliensis | | | | | | | | | | | | | | |
| Nocardia | − | + | − | + | − | + | − | + | − | + | − | + | − | + |
| globerula | | | | | | | | | | | | | | |
| Pseudomonas | − | + | − | + | − | + | − | + | − | + | − | + | − | + |
| maculicola | | | | | | | | | | | | | | |
| Bacillus | − | + | − | + | − | + | − | + | − | + | − | + | − | + |
| coagulans | | | | | | | | | | | | | | |
| Acinetobacter | − | + | − | + | − | + | − | + | − | + | − | + | − | + |
| baumannii | | | | | | | | | | | | | | |
| Stenotrophomo- | − | + | − | + | − | + | − | + | − | + | − | + | − | + |
| nas maltophlia | | | | | | | | | | | | | | |
| Pantoea stewar- | − | + | − | + | − | + | − | + | − | + | − | + | − | + |
| tiiss stewartii | | | | | | | | | | | | | | |
| Pseudomanas | − | + | − | + | − | + | − | + | − | + | − | + | − | + |
| chlororaphis | | | | | | | | | | | | | | |
| Chryseobacter- | − | + | − | + | − | + | − | + | − | + | − | + | − | + |
| ium balustinus | | | | | | | | | | | | | | |
| Duganella | − | + | − | + | − | + | − | + | − | + | − | + | − | + |
| zoogloeoides | | | | | | | | | | | | | | |
| Chryseobacter- | − | + | − | + | − | + | − | + | − | + | − | + | − | + |
| ium meni- | | | | | | | | | | | | | | |
| gosepticum | | | | | | | | | | | | | | |
| Staphylococcus | − | + | − | + | − | + | − | + | − | + | − | + | − | + |
| hominis | | | | | | | | | | | | | | |
| Nocardia | − | + | − | + | − | + | − | + | − | + | − | + | − | + |
| transvalensis | | | | | | | | | | | | | | |
| Burkolderia | − | + | − | + | − | + | − | + | − | + | − | + | − | + |
| glumea | | | | | | | | | | | | | | |
| Pediococcus | − | + | − | + | − | + | − | + | − | + | − | + | − | + |
| acidilactici | | | | | | | | | | | | | | |
| Sphingomonas | − | + | − | + | − | + | − | + | − | + | − | + | − | + |
| terrae | | | | | | | | | | | | | | |
| Corynebacte- | − | + | − | + | − | + | − | + | − | + | − | + | − | + |
| ium spp. | | | | | | | | | | | | | | |
| Gordonia | − | + | − | + | − | + | − | + | − | + | − | + | − | + |
| rubripertincta | | | | | | | | | | | | | | |
| Rhodococcus | − | + | − | + | − | + | − | + | − | + | − | + | − | + |
| rhodnii | | | | | | | | | | | | | | |
| Brevundimonas | − | + | − | + | − | + | − | + | − | + | − | + | − | + |
| vesicularis | | | | | | | | | | | | | | |
| Acinetobacter | − | + | − | + | − | + | − | + | − | + | − | + | − | + |
| calcoaceticus | | | | | | | | | | | | | | |
| Providencian | − | + | − | + | − | + | − | + | − | + | − | + | − | + |
| heimbachae | | | | | | | | | | | | | | |
| Gordonia sputi | − | + | − | + | − | + | − | + | − | + | − | + | − | + |
| Pseudomonas | − | + | − | + | − | + | − | + | − | + | − | + | − | + |
| putida | | | | | | | | | | | | | | |
| Cellulosimicro- | − | + | − | + | − | + | − | + | − | + | − | + | − | + |
| bium cellulans | | | | | | | | | | | | | | |
| Acinetobacter | − | + | − | + | − | + | − | + | − | + | − | + | − | + |
| genomospecies | | | | | | | | | | | | | | |
| Sphingomonas | − | + | − | + | − | + | − | + | − | + | − | + | − | + |
| sanguinis | | | | | | | | | | | | | | |
| Hydrogenopha- | − | + | − | + | − | + | − | + | − | + | − | + | − | + |
| ga pseudoflava | | | | | | | | | | | | | | |
| Actinomadura | − | + | − | + | − | + | − | + | − | + | − | + | − | + |
| cremea | | | | | | | | | | | | | | |
| Pseudomonas | − | + | − | + | − | + | − | + | − | + | − | + | − | + |
| flourescens | | | | | | | | | | | | | | |
| Xanthomonas | − | + | − | + | − | + | − | + | − | + | − | + | − | + |
| spp. | | | | | | | | | | | | | | |
| YEASTS | | | | | | | | | | | | | | |
| Candida | − | + | − | + | − | + | − | + | − | + | − | + | − | + |
| albicans | | | | | | | | | | | | | | |
| Candida | − | + | − | + | − | + | − | + | − | + | − | + | − | + |
| parapsilosis | | | | | | | | | | | | | | |
| Candida | − | + | − | + | − | + | − | + | − | + | − | + | − | + |
| tropicalis | | | | | | | | | | | | | | |
| Candida | − | + | − | + | − | + | − | + | − | + | − | + | − | + |
| glabrata | | | | | | | | | | | | | | |
| Kluyveromyces | − | + | − | + | − | + | − | + | − | + | − | + | − | + |
| marxianus | | | | | | | | | | | | | | |
| Hyphopichia | − | + | − | + | − | + | − | + | − | + | − | + | − | + |
| burtanii | | | | | | | | | | | | | | |
| MOLDS | | | | | | | | | | | | | | |
| Aspergillus | − | + | − | + | − | + | − | + | − | + | − | + | − | + |
| niger | | | | | | | | | | | | | | |
| Fusarium | − | + | − | + | − | + | − | + | − | + | − | + | − | + |
| oxysporum | | | | | | | | | | | | | | |
| Botrytis cinerea | − | + | − | + | − | + | − | + | − | + | − | + | − | + |
| Alternaria | − | + | − | + | − | + | − | + | − | + | − | + | − | + |
| alternata | | | | | | | | | | | | | | |
| Paecilomyces | − | + | − | + | − | + | − | + | − | + | − | + | − | + |
| lilacinus | | | | | | | | | | | | | | |
| Penicillium | − | + | − | + | − | + | − | + | − | + | − | + | − | + |
| expansum | | | | | | | | | | | | | | |

^{a} shows that the applied Silver-Zeolit ratio is weight/weight.
^{b} + mark shows refers to microbial development and growth on the construction material surfaces.
− mark refers to the absence of microbial development and growth on the construction material surfaces.

### REFERENCES

[1] Wenzel R. P., “The Econommics of Nosocomial Infections” Journal of Hospital Infection (1995) 31:79-87, 1995.
[2] Sedlbauer K., “Prediction of mould fungus formation on the surface of and inside building components”, thesis, University of Stutgart, 2001.
[3] Górny R. L., “Filamentous microorganisms and their fragments in indoor air-a review”, Annals Of Agricultural And Environmental Medicine 11:185-97, 2004.
[4] Feng, Q. L., J. Wu, G. Q. Chen, F. Z. Cui, T. M. Kim, and J. O. Kim, “A mechanistic study of the antibacterial effect of silver ions on Escherichia coli and Staphylococcus aureus” Journal of Biomedical Materials Research 52:662-668, 2000
[5] Kaduk J. A., and Fab E. J., “Crystal structure of zeolite Y as a function of ion-exchange” The Rigaku Journal, 12:14-34, 1995.
[6] Sayari, A., “Recent advances and new horizons in zeolite science and technology”, Studies in Surface Science and Catalysis, 102:1-47, 1996.
[7] Thongkasam, C., “Dealumination study of zeolite Y”, M. Sc. Report, Suranaree University of Technology, 2006.
[8] Hanke W., and K. Moeller, “Near-infrared study of the dealumination and water desorption from zeolites”, Zeolites, 4:244-250, 1984.
[9] Kawahara, K., K. Tsuruda, M. Morishita, and M. Uchida, “Antibacterial effect of silver-zeolite on oral bacteria under anaerobic conditions”, Dental Materials, 16:452-455, 2000.
[10] Galeano, B., E. Korff, and W. L. Nicholson, “Inactivation of vegetative cells, but not spores, of Bacillus anthracis, B. cereus, and B. subtilis on stainless steel surfaces coated with an antimicrobial silver- and zinc-containing zeolite formulation”, Applied and Environmental Microbiology, 69:4329, 2003.
[11] Cowan, M. M., K. Z. Abshire, S. L. Houk, and S. M. Evans, “Antimicrobial efficacy of a silver-zeolite matrix coating on stainless steel”, Journal of Industrial Microbiology and Biotechnology, 30:102-106, 2003.
[12] Hu C. H., Z. R. Xu, and M. S. Xia, “Antibacterial effect of Cu²⁺-exchanged montmorillonite on Aeromonas hydrophile and discussion on its mechanism”, Veterinary Microbiology, 109:83-88, 2005.
[13] Malachová K., P. Praus, Z. Rybková, and O. Kozak, “Antibacterial and antifungal activities of silver, copper and zinc montmorillonites”. Applied Clay Science, 4:2245, 2011.
[14] Top A. and S. Ülkü, “Silver, zinc, and copper exchange in a Na-clinoptilolite and resulting effect on antibacterial activity”, Applied Clay Science 27:13-19, 2004.
[15] Wenzel, R. P. and M. B. Edmond, “Listening to SARS: Lessons for infection control”, Annals of Internal Medicine, 139:592-593, 2003.
[16] Yamaguchie, E., F. Valena, S. M. Smith, A. Simmons, and R. H. Eng, “Colonization pattern of vancomycin-resistant Enterococcus faecium”, American Journal of Infection Control, Vol. 22, No. 4, pp. 202-206, 1994.
[17] Yoshikawa, T., M. Ihira, K. Suzuki, S. Suga, A. Tomitaka, H. Ueda, and Y. Asano, “Rapid contamination of the environments with varicella-zoster virus DNA from a patient with herpes zoster”, Journal of Medical Virology, Vol. 63, No. 1, pp. 64-66, 2001.
[18] Samuel, U. and J. P. Guggenbichler, “Prevention of catheter-related infections: The potential of a new nano-silver impregnated catheter”, International Journal of Antimicrobial Agents, Vol. 23, pp. 75-78, 2004.
[19] Furno, F., K. S. Morley, B. Wong, B. L. Sharp, P. L. Arnold, S. M. Howdle, R. Bayston, P. D. Brown, P. D. Winship, and H. J. Reid, “Silver nanoparticles and polymeric medical devices: A new approach to prevention of infection?”, Journal of Antimicrobial Chemotherapy, Vol. 54, No. 6, pp. 1019, 2004.
[20] Tesfaalem H., G. Nakhla, and E. Allouche, “Evaluation of the resistance of mortars coated with silver bearing zeolite to bacterial-induced corrosion”, Corrosion Science 50, 713-720, 2008.
[21] Bright K. R., C. P. Gerba and P. A. Rusin, “Rapid reduction of Staphylococcus aureus populations on stainless steel surfaces by zeolite ceramic coatings containing silver and zinc ions”, Journal of Hospital Infection, 52:307-309, 2002.
[22] Husheng J., H. Wensheng, W. Liqiao, X. Bingshe, and L. Xuguang, “The structures and antibacterial properties of nano-SiO2 supported silver/zinc-silver materials”, Dental Materials, 24, 244-249, 2008.
[23] Jain, P. and T. Pradeep, “Potential of silver nanoparticle-coated polyurethane foam as an antibacterial water filter”, Biotechnology and Bioengineering, Vol. 90, No. 1, pp. 59-63, 2005.
[24] Kumar, A., P. K. Vemula, P. M. Ajayan, and G. John, “Silver nanoparticle embedded antimicrobial paints based on vegetable oil”, Nature Materials, Vol. 7, No. 3, pp. 236-241, 2008.
[25] Li, Q., S. Mahendra, D. Y. Lyon, L. Brunet, M. V. Liga, D. Li, and P. J. Alvarez, “Antimicrobial nanomaterials for water disinfection and microbial control: potential applications and implications”, Water Research, Vol. 42, No. 18, pp. 4591-4602, 2008.
[26] Quintavalla, S. and L. Vicini, “Antimicrobial food packaging in meat industry”, Meat Science, Vol. 62, No. 3, pp. 373-380, 2002.
[27] Gear, A. J., T. B. Hellewell, H. R. Wright, P. M. Mazzarese, P. B. Arnold, G. T. Rodeheaver, and R. F. Edlich, “A new silver sulfadiazine water soluble gel”, Burns, Vol. 23, No. 5, pp. 387-391, 1997.
[28] Ohashi, S., S. Saku, and K. Yamamoto, “Antibacterial activity of silver inorganic agent YDA filler”, Journal of Oral Rehabilitation, Vol. 31, No. 4, pp. 364-367, 2004.
[29] Matsumura, Y., K. Yoshikata, S. Kunisaki, and T. Tsuchido, “Mode of bactericidal action of silver zeolite and its comparison with that of silver nitrate”, Applied and Environmental Microbiology, Vol. 69, No. 7, pp. 4278, 2003.
[30] Lalitha, M. K. and T. N. Vellore, “Manual on antimicrobial susceptibility testing”, URL: http://www.ijmm.org/documents/Antimicrobial.doc, 2005.

1. An antimicrobial material wherein silver, zinc copper metal ion are charged on synthesized zeolite.

2. A material according to claim 1 wherein the metal ion concentration charged on the zeolite is 0.3-1M silver nitrate.

3. A material according to claim 1 wherein the metal ion concentration charged on the zeolite is 0.5-2 M zinc chloride.

4. A material according to claim 1 wherein the metal ion concentration charged on the zeolite is 0.3-1M copper sulfate.

5. A material according to claims 2 to 4, which prevents microbial contamination for a log period by loading metal ions on zeolite, and which is durable against biological deterioration, corrosion and decays.

6. A material according to claim 5, which prevents the growth and reproduction of bacteria Escherichia coli, Staphylococcus aureus, Bacillus coagulans, Bacillus megaterium, Bacillus subtilis, Enterococcus faecium, Pseudoxanthomonas spp., Pseudomonas putida, Pseudomonas aeruginosa, Pseudomonas maculicola Pseudomanas chlororaphis, Pseudomonas flourescens, Nocardia brasiliensis, Nocardia globerula, Acinetobacter genomospecies, Acinetobacter calcoaceticus, Acinetobacter baumannii, Stenotrophomonas maltophlia, Pantoea stewartii ss stewartii, Chryseobacterium balustinus, Duganella zoogloeoides, Chryseobacterium meningosepticum, Staphylococcus hominis, Nocardia transvalensis, Burkolderia glumea, Pediococcus acidilactici/parvulus, Sphingomonas terse, Corynebacterium spp., Gordonia rubripertincta, Rhodococcus rhodnii, Brevundimonas vesicularis, Providencian heimbachae, Gordonia sputi, Cellulosimicrobium cellulans, Sphingomonas sanguinis, Hydrogenophaga pseudoflava, Actinomadura cremea, Xanthomonas spp.

7. A material according to claim 5 which prevents the growth and reproduction of ferments Candida albicans, Candida parapsilosis, Candida tropicalis, Candida glabrata, Kluyveromyces marxianus, Hyphopichia burtanii.

8. A material according to claim 5 which prevents the growth and reproduction of molds Fusarium oxysporum, Botrytis cinerea, Aspergillus niger, Alternaria alternate, Sclerotinia sclerotiorum, Paecilomyces lilacinus, Penicillium vinaceum, Penicillium expansum, Penicillium charlesii, Penicillium expansum.

9. A material according to claims 5 to 8, which shows antibacterial feature by being added to the plastic materials.

10. A material according to claims 5 to 8, which shows antibacterial feature by being added to the cement and plaster.

11. A material according to claims 5 to 8, which shows antibacterial feature by being added to all kind of painting.

12. A material according to claims 9 to 11, which can be applied by being added to raw materials of technological products and surface paints especially in all kinds of metal and plastic household appliances, medial supplies that require hygiene in hospitals and clinics, all painted metal and plastic surfaces used in public areas, house paints and coatings, surfaces of the vehicles, metal and plastic parts of the air conditioners, television and computer.
